(19) United States
(12) Patent Application Publication
(10) Pub. No.: US 2025/0350334 A1
(43) Pub. Date: Nov. 13, 2025

(54) METHOD AND DEVICE FOR CHANNEL STATE INFORMATION REPORTING IN WIRELESS COMMUNICATION SYSTEM

(71) Applicant: Samsung Electronics Co., Ltd., Gyeonggi-do (KR)

(72) Inventors: Sangwon JUNG, Gyeonggi-do (KR); Seunghyun LEE, Gyeonggi-do (KR); Huiwon KIM, Gyeonggi-do (KR)

(21) Appl. No.: 19/202,489

(22) Filed: May 8, 2025

(30) Foreign Application Priority Data
May 8, 2024 (KR) 10-2024-0060798

(51) Int. Cl. H04B 7/06; H04W 24/10

(52) U.S. Cl. CPC H04B 7/0626; H04B 7/0632; H04B 7/0639; H04W 24/10

(57) ABSTRACT

The disclosure relates to a fifth generation (5G) communication system or a sixth generation (6G) communication system for supporting higher data rates beyond a fourth generation (4G) communication system. A method of a base station in a wireless communication system includes transmitting, to a user equipment (UE), channel state information (CSI) report configuration information including configuration information configuring the UE to report precoding matrix index (PMI) quality information (PQI), transmitting a CSI-reference signal (CSI-RS) to the UE, and receiving, from the UE, a CSI and the PQI determined based on the CSI report configuration information and the CSI-RS.

### CROSS-REFERENCE TO RELATED APPLICATION(S)

This application is based on and claims priority under 35 U.S.C. § 119 to Korean Patent Application No. 10-2024-0060798, filed on May 8, 2024 in the Korean Intellectual Property Office, the disclosure of which is incorporated herein by reference in its entirety.

### BACKGROUND

### 1. Field

The disclosure relates generally to wireless communication systems and, more particularly, to channel state information (CSI) reporting through enhanced multi-user (MU) multiple input multiple output (MIMO) scheduling performance considering the quality of precoding matrix index (PMI) during CSI feedback.

### 2. Description of Related Art

Considering the development of wireless communication from generation to generation, technologies have been developed mainly for services targeting humans, such as voice calls, multimedia services, and data services. Following the commercialization of 5th-generation (5G) communication systems, it is expected that the number of connected devices will continuously grow and will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. To provide various services by connecting hundreds of billions of devices and things in the 6th-generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of terahertz (THz) (1,000 gigahertz (GHz))-level bits per second (bps) and a radio latency less than 100 microseconds (μsec), and thus will be 50 times as fast as 5G communication systems and have the 1/10 radio latency thereof.

To accomplish such a high data rate and an ultra-low latency, it has been considered to implement 6G communication systems in a THz band (for example, 95 GHz to 3 THz bands). It is expected that, due to severe path loss and atmospheric absorption in the THz bands than those in millimeter wave (mmWave) bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive MIMO, full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, to improve the spectral efficiency and the overall network performances, the following technologies have been developed for 6G communication systems: a full-duplex technology for enabling an uplink transmission and a downlink (DL) transmission to simultaneously use the same frequency resource, a network technology for utilizing satellites, high-altitude platform stations (HAPS), and the like in an integrated manner, an improved network structure for supporting mobile base stations (BSs) and the like and enabling network operation optimization and automation and the like; a dynamic spectrum sharing technology via collision avoidance based on a prediction of spectrum usage, an use of artificial intelligence (AI) in wireless communication for improvement of overall network operation by utilizing AI from a designing phase for developing 6G and internalizing end-to-end AI support functions, and a next-generation distributed computing technology for overcoming the limit of UE computing ability through reachable super-high-performance communication and computing resources (such as mobile edge computing (MEC), clouds, and the like) over the network.

In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will enable the next hyper-connected experience to ensue. Particularly, it is expected that services such as immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

Long term evolution (LTE), ultra mobile broadband (UMB), 802.16m or other post-third generation (3G) mobile communication systems are based on multi-carrier multiple access schemes and feature the use of various techniques for enhanced transmission efficiency, such as MIMO, multiple antennas, beam-forming, adaptive modulation and coding (AMC), and channel sensitive scheduling. These techniques enhance system capability by, e.g., concentrating transmit power coming from several antennas depending on channel quality, adjusting the amount of data transmitted, or selectively transmitting data to the user with a good channel quality to enhance transmission efficiency. Such schemes mostly operate based on the channel status information between the BS and the UE. Accordingly, the eNB or the UE is required to measure the channel status between the eNB and the UE. To that end, a CSI-RS is used. The gNB indicates a DL transmission and UL reception device positioned in a predetermined place, and one gNB performs communication on multiple cells. A plurality of gNBs is geographically dispersed in one mobile communication system, and each gNB performs communication on the plurality of cells.

The LTE/LTE-advanced (LTE-A) or other 3G or fourth generation (4G) mobile communication systems utilizes the MIMO technique in which transmission is performed using a plurality of transmit/receive antennas to increase system capability and data transmission rate. The MIMO technique makes use of a plurality of transmission/reception antennas to spatially separate and transmit a plurality of information streams, which is referred to as spatial multiplexing. Generally, the number of information streams to which spatial multiplexing may be applied may vary depending on the number of antennas of the transmitter and receiver, and the number of information streams to which spatial multiplexing may apply may be referred to as the rank of the corresponding transmission. The MIMO technique supported by the LTE/LTE-A release 11 and its predecessors support spatial multiplexing for 16 transmission antennas and 8 reception antennas and supports up to eight ranks.

In new radio (NR) access technology, which is a 5G mobile communication system being discussed, the system design aims to be able to support various services such as enhanced mobile broadband (eMBB), ultra reliable low latency communications (URLLC), and massive machine-type communications (mMTC), and allows time and frequency resources to be flexibly transmitted by minimizing and aperiodically transmitting reference signals.

Understanding and correctly estimating a channel between a user equipment (UE) and a BS (e.g., a gNode B (gNB)) is important in efficient and effective wireless communication. To correctly estimate the status of the DL channel, the gNB may transmit, to the UE, a CSI reference signal (CSI-RS) for DL channel measurement, and the UE may report (e.g., feedback) information about the channel measurement, e.g., CSI, to the gNB. Through the DL channel measurement, the gNB may select an appropriate communication parameter to efficiently and effectively perform wireless data communication with the UE.

In the 3GPP LTE specifications, MIMO has been identified as an essential feature for achieving high system throughput requirements and remains so in NR. One of the main components of the MIMO transmission scheme is to accurately obtain CSI from the eNB, or transmission and reception point (TRP). In particular, for MU-MIMO, the availability of accurate CSI is necessary to ensure high MU performance. In a time division duplex (TDD) system, CSI may be obtained using sounding reference signal (SRS) transmission dependent on channel reciprocity. In a frequency division duplex (FDD) system, CSI may be obtained using CSI-RS transmission from the eNB and CSI acquisition from the UE and feedback. In legacy FDD systems, the CSI feedback framework is ‘implicit’ in the form of CQI/PMI/RI derived from the codebook assuming single user (SU) transmission from the eNB.

Due to the inherent SU assumption when deriving the CSI, such implicit CSI feedback is inappropriate for MU transmission. Since NR systems are more likely to be MU-centric, this SU-MU CSI mismatch prevents achieving high MU performance gains. Another problem with implicit feedback is scalability due to more antenna ports in the eNB. For many antenna ports, the codebook design for implicit feedback is complex, and the designed codebook does not ensure a legitimate performance gain in real deployment scenarios.

There is a need in the art for a method and device that may enhance MU-MIMO scheduling performance considering the quality of PMI during CSI feedback.

### SUMMARY

The disclosure has been made to address at least the above-mentioned problems and/or disadvantages and to provide at least the advantages described below.

Accordingly, an aspect of the disclosure is to provide a method and device for enabling CSI reporting in a wireless communication system.

An aspect of the disclosure is to provide a method and device that may enhance MU-MIMO scheduling performance considering the quality of PMI during CSI feedback.

In accordance with an aspect of the disclosure, a method of a BS in a wireless communication system includes transmitting, to a UE, CSI report configuration information including configuration information configuring the UE to report PMI quality information (PQI) about a PMI, transmitting a CSI-reference signal (CSI-RS) to the UE, and receiving, from the UE, a CSI and the PQI about the PMI determined based on the CSI report configuration information and the CSI-RS.

In accordance with an aspect of the disclosure, a method of a UE in a wireless communication system may include receiving, from a BS, CSI report configuration information including configuration information configuring the UE to report PMI quality information (PQI), receiving a CSI-reference signal (CSI-RS) from the BS, and transmitting, to the BS, a CSI and the PQI determined based on the CSI report configuration information and the CSI-RS.

In accordance with an aspect of the disclosure, in a wireless communication system, a BS includes a transceiver and a processor. The processor may control to transmit, to a UE, CSI report configuration information including configuration information configuring the UE to report PQI, control to transmit a CSI-RS to the UE, and receive, from the UE, a CSI and the PQI determined based on the CSI report configuration information and the CSI-RS.

In accordance with an aspect of the disclosure, in a wireless communication system, a UE includes a transceiver and a processor. The processor may receive, from a BS, CSI report configuration information including configuration information configuring the UE to report PQI, receive a CSI-RS from the BS, and control to transmit, to the BS, a CSI and the PQI determined based on the CSI report configuration information and the CSI-RS.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates a CSI feedback procedure according to an embodiment;

FIG. 2 illustrates scheduling a plurality of UEs by a BS according to an embodiment;

FIG. 3 illustrates exchanging messages for a CSI feedback procedure between a BS and a UE according to an embodiment;

FIG. 4 illustrates fields setting a PMI quality-related CSI report according to an embodiment;

FIG. 5 illustrates sub fields for a PMI quality report according to an embodiment;

FIG. 6 illustrates a sub field for a PMI quality report according to an embodiment;

FIG. 7 illustrates sub fields for a PMI quality report according to an embodiment;

FIG. 8 illustrates a sub field for a PMI quality report according to an embodiment;

FIG. 9 illustrates transmitting a PMI quality report on an uplink according to an embodiment;

FIG. 10 illustrates a configuration of a UE according to an embodiment; and

FIG. 11 illustrates a configuration of a BS according to an embodiment.

### DETAILED DESCRIPTION

Hereinafter, embodiments of the disclosure are described in detail with reference to the accompanying drawings. The same reference denotations may be used to refer to the same or similar elements throughout the specification and the drawings.

Detailed descriptions of known functions or configurations that may make the subject matter of the disclosure unclear will be omitted for the sake of clarity and conciseness.

Some elements may be exaggerated or schematically shown. The size of each element does not necessarily reflects the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The same reference numeral denotes the same element throughout the specification.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise. As used herein, terms denoting signals, channels, control information, and device components are provided as an example for ease of description. Although the disclosure describes various embodiments using terms used in some communication standards (e.g., 3rd generation partnership project (3GPP)), this is merely an example. Various embodiments of the disclosure may be easily modified and applied in other communication systems.

Herein, the BS may be an entity allocating resource to terminal and may be at least one of gNode B, gNB, eNode B, eNB, Node B, wireless access unit, BS controller, or node over network. The BS may be a network entity including at least one of an integrated access and backhaul (IAB) donor, which is a gNB providing network access to UE(s) through a network of backhaul and access links in the NR system, and an IAB-node, which is a radio access network (RAN) node supporting NR backhaul links to the IAB-donor or another IAB-node and supporting NR access link(s) to UE(s). The UE is wirelessly connected through the IAB-node and may transmit/receive data to and from the IAB-donor connected with at least one IAB-node through the backhaul link.

The UE may include a mobile station (MS), a cellular phone, a smart phone, a computer, or various devices capable of performing a communication function. The DL refers to a wireless transmission path of signal transmitted from the BS to the terminal, and the UL refers to a wireless transmission path of signal transmitted from the terminal to the BS. Although the LTE and LTE-A systems may be described below as an example, embodiments of the disclosure may be applied to other communication systems having a similar technical background or channel shape. For example, 5G mobile communication technology (5G, new radio, NR) or 6G developed after LTE-A may be included therein, and 5G or 6G below may be a concept including legacy LTE, LTE-A and other similar services. The embodiments may be modified in such a range as not to significantly depart from the scope of the disclosure under the determination by one of ordinary skill in the art and such modifications may be applicable to other communication systems.

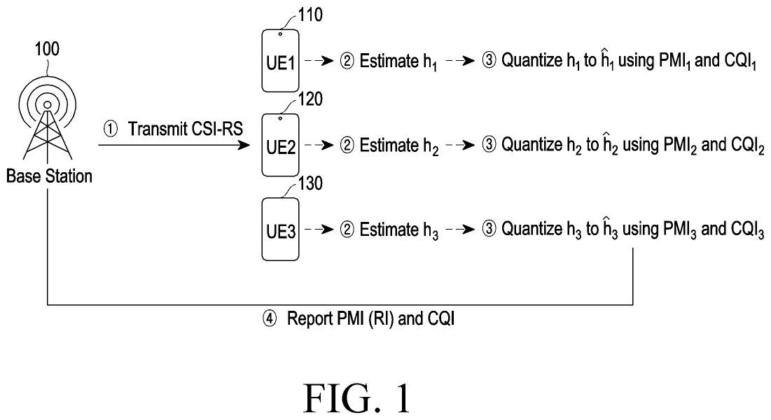

FIG. 1 illustrates a CSI feedback procedure according to an embodiment.

Referring to FIG. 1, in step 1, the BS 100 may transmit a CSI-RS through DL for MU-MIMO channel estimation. The CSI-RS may be used for channel sounding in a DL direction. The CSI-RS may be transmitted to measure the characteristics of a radio channel to determine (or process) modulation, code rate, and/or beamforming. Specific instances of the CSI-RS may be configured for time/frequency tracking and mobility measurements. The CSI-RS is transmitted for the UEs belonging to one cell, and may be used to measure the channel state, and a plurality of CSI-RSs may be transmitted in one cell.

In step 2, the first UE (UE1), second UE (UE2) and third UE (UE3) may receive CSI-RS from the BS 100. Specifically, the first UE 110 may receive a CSI-RS from the BS 100 and estimate a radio channel (or channel matrix) h₁ between the first UE 110 and the BS 100 using the CSI-RS. The first UE 110 may quantize (or determine) the radio channel (or channel matrix) h₁ using a first precoding matrix PMI₁ and a first channel quality indicator (CQI) CQI₁ to generate (or determine) ĥ₁. The first UE 110 may transmit PMI₁ and CQI₁ to the BS 100.

The second UE 120 may receive a CSI-RS from the BS 100 and estimate a radio channel (or channel matrix) h₂ between the second UE 120 and the BS 100 using the CSI-RS. The second UE 120 may quantize (or determine) the radio channel (or channel matrix) h₂ using a second PMI (PMI₂) and a second CQI (CQI₂) to generate (or determine) ĥ₂. The second UE 120 may transmit the PMI₂ and the CQI₂ to the BS 100.

The third UE 130 may receive a CSI-RS from the BS 100 and estimate a radio channel (or channel matrix) h₃ between the third UE 130 and the BS 100 using the CSI-RS. The third UE 130 may quantize (or determine) the radio channel (or channel matrix) h₃ using a third PMI (PMI₃) and a third CQI (CQI₃) to generate (or determine) ĥ₃. The third UE 130 may transmit the PMI₃ and the CQI₃ to the BS 100.

In step 4, the BS 100 may report the PMI and CQI, where the PMI includes a rank indicator.

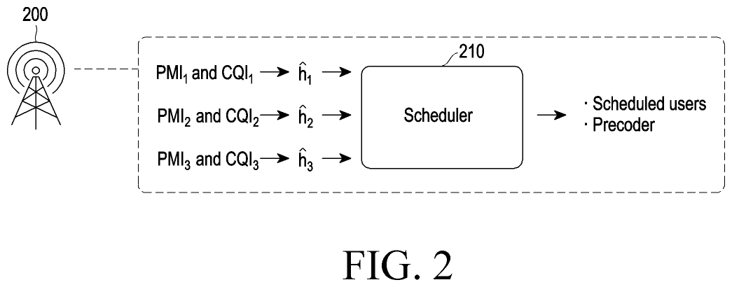

FIG. 2 illustrates scheduling a plurality of UEs by a BS according to an embodiment.

Referring to FIGS. 1 and 2, the BS 200 may determine (or identify) the quantized first channel information (ĥ₁) using PMI₁ and CQI₁ received from the first UE 110. The BS 200 may determine (or identify) the quantized second channel information (ĥ₂) using PMI₂ and CQI₂ received from the second UE 120. The BS 200 may determine (or identify) the quantized third channel information (ĥ₃) using PMI₃ and CQI₃ received from the third UE 130.

Referring to FIG. 2, the BS 200 may include a scheduler 210 for MU-MIMO scheduling. The scheduler 210 may perform scheduling on each UE considering the channel environment of each UE using the quantized first channel information (ĥ₁), the quantized second channel information (ĥ₂), and the quantized third channel information (ĥ₃). The scheduler 210 may calculate a precoder for each UE using the quantized first channel information (ĥ₁), the quantized second channel information (ĥ2₎, and the quantized third channel information (ĥ₃).

However, if the scheduler 210 may not know the quality difference between the quantized channel information (ĥ₁, ĥ₂, or ĥ₃) and actual channel information (h₁, h₂, or h₃), and the quality difference between the quantized channel information (ĥ₁, ĥ₂, or ĥ₃) and actual channel information (h₁, h₂, or h₃) is large, MU-MIMO scheduling performance may deteriorate.

Performance during MU-MIMO scheduling may be determined based on the quality of the PMI (or codebook). A squared generalized cosine similarity (SGCS) or a generalized cosine similarity (GCS) may be used as commonly used measurement items (metric to value) to evaluate the quality of the PMI (or codebook).

When a zero-forcing (ZF) precoder is assumed, the relationship between the SGCS of the kth UE and the signal to interference noise ratio (SINR) of the kth UE may be determined based on Equations (1) and (2) below.

$$SINR {{(}^{SINR}}_{k} ) of kth UE = \frac{ρ {\vert {h}_{k}^{H} {w}_{k} \vert}^{2}}{1 + ρ {\sum }_{j \neq k} {\vert {h}_{k}^{H} {w}_{j} \vert}^{2}} \approx \frac{ρ {‖ {h}_{k} ‖}^{2} {cos}^{2} {θ}_{k}}{1 + ρ {‖ {h}_{k} ‖}^{2} {sin}^{2} {θ}_{k}} \qquad ( 1 )$$

In Equation (1), hₖ indicates the channel (or channel matrix) of the kth UE, wₖ indicates the precoder (or precoder matrix) of the kth UE, and ρ may be a set coefficient.

$$SGCS ( {SGCS}_{k} ) of kth UE = \frac{{\vert {h}_{k}^{H} {\hat{h}}_{k} \vert}^{2}}{\vert {h}_{k} \vert \vert {\hat{h}}_{k} \vert} \qquad ( 2 )$$

Referring to Equations (1) and (2), SGCS((SGCSₖ) of the kth UE may be represented as

$$\frac{{cos}^{2} {θ}_{k}}{{sin}^{2} {θ}_{k}} .$$

For example, as the SGCS approaches 0, the SINR may also approach 0. MU-MIMO performance may be enhanced by utilizing SGCS. MU pool management, selection priority, and/or SINR offset may be determined using SGCS.

Although FIGS. 1 and 2 illustrate MU-MIMO scheduling for three UEs for convenience of description, the technical idea of the disclosure is not limited to the number of UEs and may also be applied to MU-MIMO scheduling for various numbers of UEs.

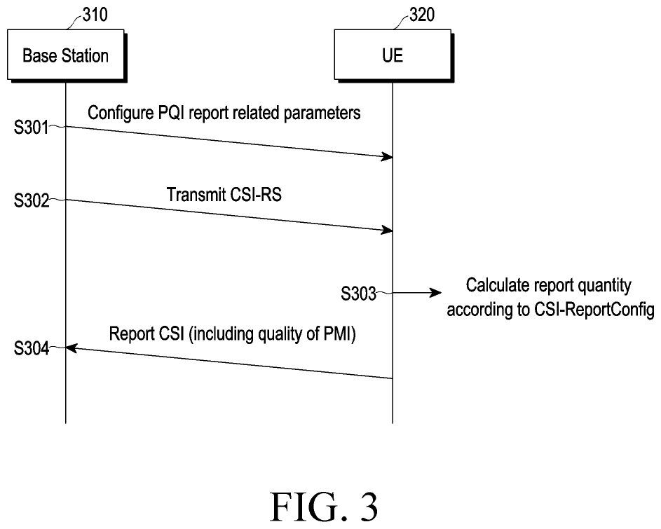

FIG. 3 illustrates exchanging messages for a CSI feedback procedure between a BS and a UE according to an embodiment.

Referring to FIG. 3, in step S301, the BS 310 may transmit a first message for setting parameters related to the PQI report of the UE 320 to the UE 320. The first message may include parameters related to the PQI report for the UE 320 and CSI report configuration information (CSI-ReportConfig) for the UE 320. The first message may be a radio resource signaling (RRC) message transmitted through higher layer signaling and may be included in a dynamically configured DL control information (DCI).

The CSI-ReportConfig may set a frequency and time position of the CSI-RS resource element (RE). The number of ports the corresponding CSI-RS has may be set by setting the number of antennas in the CSI-ReportConfig, Resource config may set the RE position in the RB, and Subframe config may set the period and offset of the subframe.

In step S302, the BS 310 may transmit a CSI-RS to the UE 320 so that the UE 320 may report the channel state. In step S303, the UE 320 may calculate the CSI report quantity according to the CSI-ReportConfig.

In step S304, the UE 320 may transmit a CSI including PQI to the BS 310. The PQI may include at least one of an SGCS parameter and a GCS parameter. The CSI may include at least one of PMI, PQI, CQI, CSI-RS resource indicator (CRI), SS/PBCH resource block indicator (SSBRI), layer indicator (LI), rank indicator (RI), and L1-reference signal received power (RSRP).

The RI may indicate the number of spatial layers that the UE 320 may receive in the current channel state. The PMI may indicate a precoding matrix preferred by the UE 320 in the current channel state. The CQI may indicate a maximum data rate that the UE 320 may receive in the current channel state. The CQI may be replaced with a signal to interference and noise ratio (SINR), a maximum error correction coding rate and modulation method, and data efficiency per frequency that may be used similarly to the maximum data transmission rate.

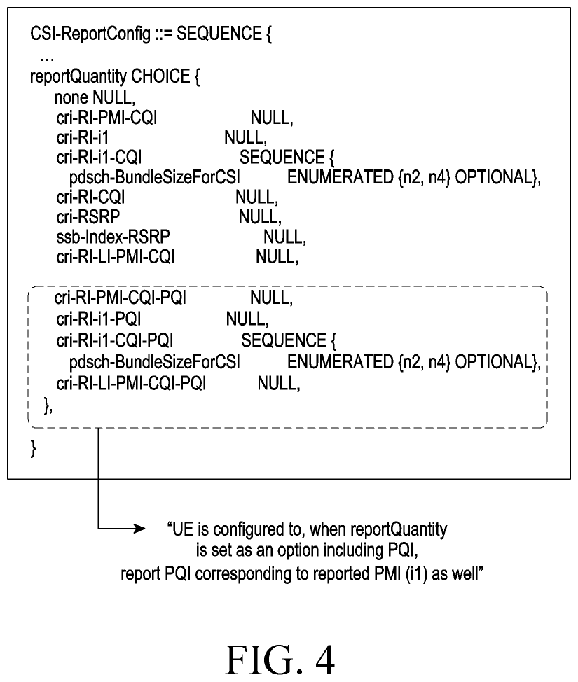

FIG. 4 illustrates fields setting a PMI quality-related CSI report according to an embodiment.

Referring to FIGS. 3 and 4, the BS 310 may transmit an RRC message including CSI-ReportConfig to the UE 320 through higher layer signaling.

The CSI-ReportConfig may configure a periodic or semi-persistent report transmitted through the physical UL control channel (PUCCH) in the cell including CSI-ReportConFIG. The CSI-ReportConfig may configure a semi-persistent or aperiodic report transmitted through a physical UL shared channel (PUSCH) triggered by DCI received in the cell including the CSI-ReportConfig.

Referring to FIG. 4, a reportQuantity field in the CSI-ReportConfig may indicate a target to be measured. The type of quality may be divided into CSI-related quantities and L1-RSRP-related quantities. Herein, PQI related to the PQI report may be set (or included) in the reportQuantity field in the CSI-ReportConfig.

Referring to FIG. 4, the reportQuantity field may indicate one of cri-RI-PMI-CQI, cri-RI-i1, cri-RI-i1-CQI, cri-RI-CQI, cri-RSRP, synchronization signal block (ssb)-Index-RSRP, cri-RI-LI-PMI-CQI, cri-RI-PMI-CQI-PQI, cri-RI-i1-PQI, cri-RI-i1-CQI-PQI, and cri-RI-LI-PMI-CQI-PQI.

cri-RI-PMI-CQI may indicate that the target to be measured by the UE is CRI, RI, PMI, and CQI. In this case, the UE may report a preferred precoder matrix for the entire reporting band or a preferred precoder matrix for each subband.

cri-RI-i1 may indicate that the target to be measured by the UE is CRI, RI, and i1. In this case, the UE may report a PMI composed of single wideband indication (i1) for the entire CSI reporting band.

cri-RI-i1-CQI may indicate that the target to be measured by the UE is CRI, RI, i1, and CQI. In this case, the UE may report a PMI composed of i1 for the entire CSI reporting band. The physical resource block (PRB) bundling size for CQI calculation may be configured by the higher layer parameter pdsch-BundleSizeForCSI. According to the value indicated by pdsch-BundleSizeForCSI, the UE may calculate the CQI by dividing the total bandwidth by the corresponding size. For example, when total bandwidth=100 RB, pdsch-BundleSizeForCSI=20 RB, the UE may calculate the CQI in five areas and map it to one CQI and then report the CQI. For example, when total bandwidth=100 RB, pdsch-BundleSizeForCSI=10 RB, the UE may calculate the CQI in 10 areas and map it to one CQI and then report the CQI.

cri-RI-CQI may indicate that the target to be measured by the UE is CRI, RI, and CQI.

cri-RSRP may indicate that the target to be measured by the UE is CRI-RSRP.

ssb-Index-RSRP may indicate that the target to be measured by the UE is SSB index RSRP.

cri-RI-LI-PMI-CQI may indicate that the target to be measured by the UE is CRI, RI, LI, PMI, and CQI. In this case, the UE may report a preferred precoder matrix for the entire reporting band or a preferred precoder matrix for each subband.

cri-RI-PMI-CQI-PQI may indicate that the target to be measured by the UE is CRI, RI, PMI, CQI, and PQI. In this case, the UE may report a preferred precoder matrix for the entire reporting band or a preferred precoder matrix for each subband.

cri-RI-i1-PQI may indicate that the target to be measured by the UE is CRI, RI, i1, and PQI. In this case, the UE may report a PMI composed of single wideband indication (i1) for the entire CSI reporting band.

cri-RI-i1-CQI-PQI may indicate that the target to be measured by the UE is CRI, RI, i1, CQI, and PQI. In this case, the UE may report a PMI composed of i1 for the entire CSI reporting band. The PRB bundling size for CQI calculation may be configured by the higher layer parameter pdsch-BundleSizeForCSI. According to the value indicated by pdsch-BundleSizeForCSI, the UE may calculate the CQI by dividing the total bandwidth by the corresponding size.

cri-RI-LI-PMI-CQI-PQI may indicate that the target to be measured by the UE is CRI, RI, LI, PMI, CQI, and PQI. In this case, the UE may report a preferred precoder matrix for the entire reporting band or a preferred precoder matrix for each subband.

The UE may report a PQI corresponding to the reported PMI (i1) when the reportQuantity field is set to include the PQI.

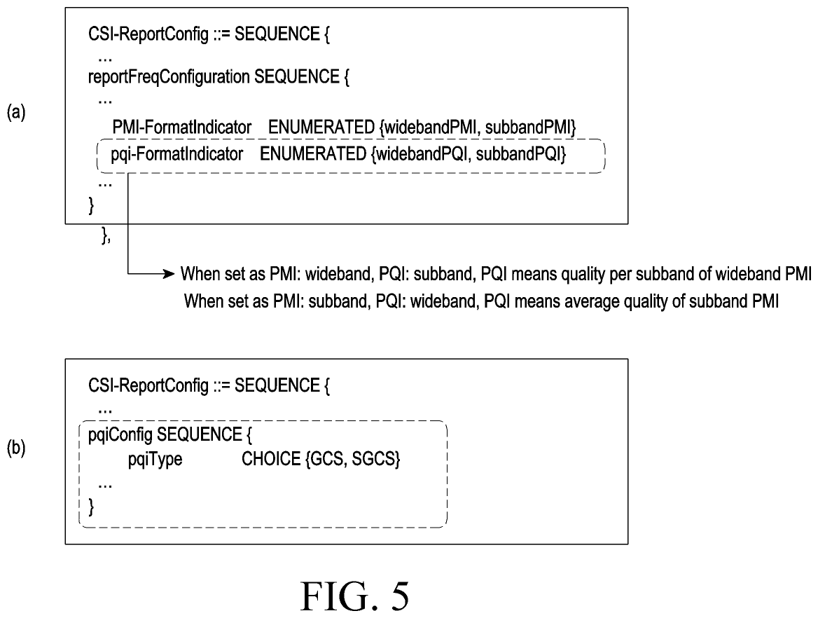

FIG. 5 illustrates sub fields for a PMI quality report according to an embodiment.

Referring to FIGS. 3 and 5, the BS 310 may transmit an RRC message including CSI-ReportConfig to the UE 320 through higher layer signaling.

Referring to FIG. 5, in section (a), the CSI-ReportConfig may include information (reportFreqConfiguration) indicating the reporting configuration in the frequency domain. reportFreqConfiguration may include a PMI-FormatIndicator and a pqi-FormatIndicator. The PMI-FormatIndicator may indicate whether the UE should report a single (wideband) PMI or the UE should report multiple (subband) PMIs.

The pqi-FormatIndicator may be set to widebandPQI or subbandPQI. The PMI-FormatIndicator may indicate whether the UE should report a single (wideband) PQI or multiple (subband) PQIs.

For example, if the PMI-FormatIndicator is set to wideband PMI and PMI-FormatIndicator is set to subband PQI, the PQI may indicate the subband-specific quality of wideband PMI. If PMI-FormatIndicator is set to subband PMI and PMI-FormatIndicator is set to wideband PQI, PQI may indicate the average quality of subband PMIs.

In section (b), the CSI-ReportConfig may include a pqiConfig field for configuring the PQI to be reported by the UE. The pqiConfig field may include a pqiType field for setting the type indicating the quality of PMI. The pqiType field may indicate that the type indicating the quality of PMI is GCS or SGCS.

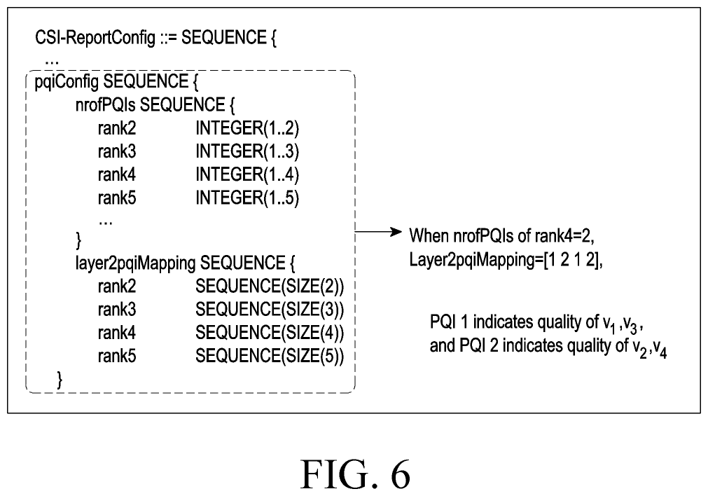

FIG. 6 illustrates a sub field for a PMI quality report according to an embodiment.

Referring to FIGS. 3 and 6, the BS 310 may transmit an RRC message including CSI-ReportConfig to the UE 320 through higher layer signaling.

Various types of information reporting may be possible according to the number of reporting PQIs per RI and the layer to PQI mapping rule. For example, the 4-layer PMI may be composed as shown in Equation (3) below.

$$W = [ \begin{matrix}⋮ & ⋮ & ⋮ & ⋮ \\ {v}_{1} & {v}_{2} & {v}_{3} & {v}_{4} \\ ⋮ & ⋮ & ⋮ & ⋮\end{matrix} ] \qquad ( 3 )$$

In Equation (3), when four PQIs are used, PQIs 1 to 4 may represent the quality of PMI of V₁ to V₄, respectively. For example, when two PQIs are used, PQI 1 may represent an average of PMI qualities of V₁ and V₂, and PQI 2 may represent an average of PMI qualities of V₃ and V₄.

The CSI-ReportConfig may include a pqiConfig field for setting the PQI to be reported by the UE. The pqiConfig field may include a nrofPQIs field indicating the number of PQIs reported in each rank (or RI), and a layer2pqiMapping field mapping each layer and PQI.

For example, when the nrofPQIs field for Rank4 is set to 2 and the layer2pqiMapping field is set to [1 2 1 2], PQI 1 may represent the average of the quality of PMI of V₁ and V₃, and PQI 2 may represent the average of the quality of PMI of V₂ and V₄.

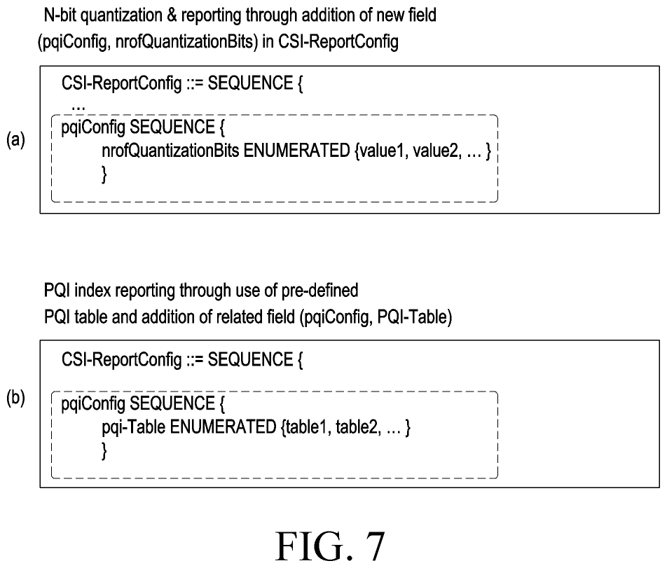

FIG. 7 illustrates sub fields for a PMI quality report according to an embodiment.

Referring to FIGS. 3 and 7, the BS 310 may transmit an RRC message including CSI-ReportConfig to the UE 320 through higher layer signaling.

Referring to FIG. 7, in section (a), the CSI-ReportConfig may include a pqiConfig field for setting the PQI to be reported by the UE. The pqiConfig field may include a nrofQuantizationBits field indicating N-bit quantization and reporting for PQI to be reported by the UE. For example, the BS may set the value of the nrofQuantizationBits field to 2 to indicate 2-bit quantization and reporting for PQI to be reported by the UE.

In section (b), the CSI-ReportConfig may include a pqiConfig field for configuring the PQI to be reported by the UE. The pqiConfig field may include a pqi-Table field indicating a predefined PQI table.

For example, if the value of the pqi-Table field is set to table 1, the PQI table of Table 1 below may be set.

TABLE 1
2-bit PQI

| PQI index | PQI value |
|---|---|
| 0 | <0.3 |
| 1 | <0.5 |
| 2 | <0.8 |
| 3 | <1 |

For example, if the value of the pqi-Table field is set to table1, the UE may transmit the PQI index using 2-bit PQI Table 1. For example, if the UE uses 2-bit PQI table 1 and the PQI value is 0.4, the UE may set the value of the PQI index to 1 and report this value. For example, if the UE uses 2-bit PQI table 1 and the PQI value is 0.7, the UE may set the value of the PQI index to 2 and report this value.

For example, if the value of the pqi-Table field is set to table2, the PQI table of Table 2 below may be set.

TABLE 2
1-bit PQI

| PQI index | PQI value |
|---|---|
| 0 | <0.5 |
| 1 | <1 |

For example, if the value of the pqi-Table field is set to table2, the UE may transmit the PQI index using 1-bit PQI Table 2. For example, if the UE uses 1-bit PQI table 2 and the PQI value is 0.4, the UE may set the value of the PQI index to 0 and report this value. For example, if the UE uses 1-bit PQI table 2 and the PQI value is 0.7, the UE may set the value of the PQI index to 1 and report this value.

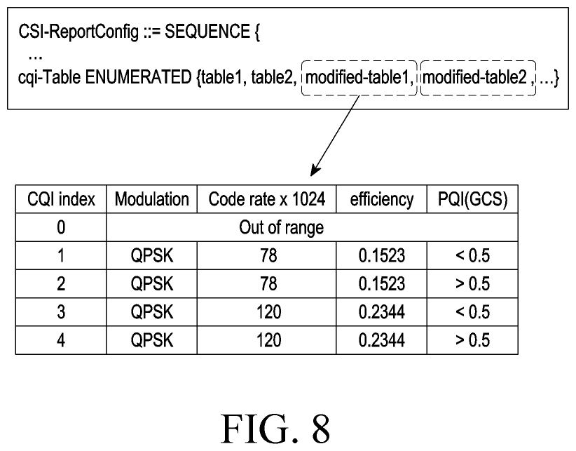

FIG. 8 illustrates a sub field for a PMI quality report according to an embodiment.

Referring to FIGS. 3 and 8, the BS 310 may transmit an RRC message including CSI-ReportConfig to the UE 320 through higher layer signaling.

Referring to FIG. 8, the CSI-ReportConfig may include a cqi-Table field indicating the CQI table to be used by the UE for CQI calculation.

For example, if the cqi-Table field is set to table1, the CQI table of Table 3 below may be set.

TABLE 3

| | | | |
|---|---|---|---|
| CQI index | Modulation | Code rate × 1024 | Efficiency |

| | |
|---|---|
| 0 | Out of range |

| | | | |
|---|---|---|---|
| 1 | QPSK | 78 | 0.1523 |
| 2 | QPSK | 78 | 0.1523 |
| 3 | QPSK | 120 | 0.2344 |
| 4 | QPSK | 120 | 0.2344 |

For example, if the CQI table in Table 3 may be set and the CQI index is 1, Modulation may be set to quadrature phase shift keying (QPSK), Code rate×1024 is set to 78, and efficiency may be set to 0.1523.

For example, if the cqi-Table field is set to modified-table1, the CQI table of Table 4 below may be set.

TABLE 4

| CQI index | Modulation | Code rate × 1024 | efficiency | PQI (GCS) |
|---|---|---|---|---|
| 0 | Out of range | | | |
| 1 | QPSK | 78 | 0.1523 | <0.5 |
| 2 | QPSK | 78 | 0.1523 | >0.5 |
| 3 | QPSK | 120 | 0.2344 | <0.5 |
| 4 | QPSK | 120 | 0.2344 | >0.5 |

For example, if the CQI table of Table 4 is set and the CQI index is 1, modulation may be set to QPSK, code rate×1024 may be set to 78, efficiency may be set to 0.1523, and PQI for GCS may be set to less than 0.5.

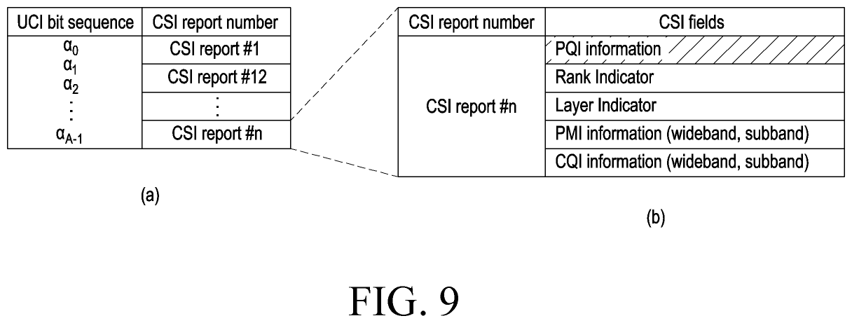

FIG. 9 illustrates transmitting a PMI quality report on a UL according to an embodiment. Referring to FIGS. 3 and 9, the UE 320 may transmit a CSI including PQI to the BS 310.

Referring to FIG. 9, in section (a), the CSI fields of the CSI report may be mapped to a UCI bit sequence a₀, a₁, a₁, a₃, . . . , a_{A-1} starting from upper to lower part a₀. The most significant bit of each field may be mapped to the lowest order information bit of the corresponding field. The most significant bit of the first field may be mapped to a₀.

In section (a) and section (b), if the CSI report number is CSI report #n, it may include PQI information, RI, LI, PMI information (wideband, subband), and CQI information (wideband, subband).

However, the CSI of the disclosure may be transmitted based on various CSI reporting mapping rules other than those in FIG. 9.

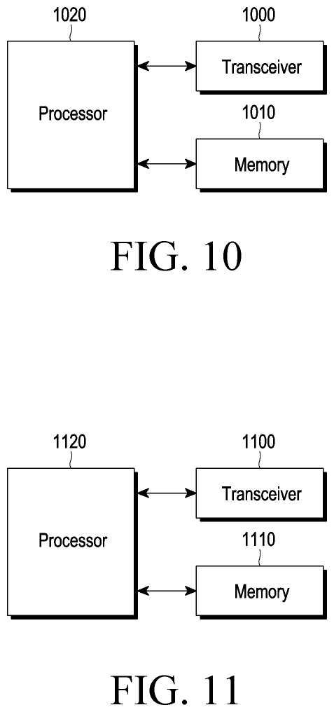

FIG. 10 illustrates a configuration of a UE according to an embodiment.

Referring to FIG. 10, a UE may include a processor 1020 controlling the overall operation of the UE, a transceiver 1000 including a transmitter and a receiver, and memory 1010. However, the UE may include more or fewer components than those shown in FIG. 10.

The transceiver 1000 may transmit/receive signals to/from the BS or network entity.

The signals transmitted/received with the BS may include control information and data. The transceiver 1000 may receive signals via a radio channel, output the signals to the processor 1020, and transmit signals output from the processor 1020 via a radio channel. The transceiver 1000 may also be referred to as a transmission/reception unit.

The processor 1020 may control the UE to perform any one of the above-described embodiments. The processor 1020, the memory 1010, and the transceiver 1000 are not necessarily implemented in separate modules but rather as a single component, e.g., a single chip. The processor 1020 and the transceiver 1000 may be electrically connected with each other. The processor 1020 may be an application processor (AP), a communication processor (CP), a circuit, an application-specific circuit, or at least one processor.

The UE in a wireless communication system comprises: at least one transceiver; at least one processor communicatively coupled to the at least one transceiver; and at least one memory, communicatively coupled to the at least one processor, storing instructions executable by the at least one processor individually or in any combination to cause the UE to: receive, from a base station, channel state information (CSI) report configuration information including configuration information configuring the UE to report precoding matrix index (PMI) quality information (PQI); receive a CSI-reference signal (CSI-RS) from the base station; and transmit, to the base station, a CSI and the PQI determined based on the CSI report configuration information and the CSI-RS.

The memory 1010 may store a default program for operating the UE, application programs, and data, such as configuration information. The memory 1010 provides the stored data according to a request of the processor 1020. The memory 1010 may include a storage medium, such as read only memory (ROM), random access memory (RAM), hard disk, compact disc (CD)-ROM, and digital versatile disc (DVD), or a combination of storage media. There may be provided a plurality of memories 1010. The processor 1020 may perform the above-described embodiments based on a program for performing the above-described embodiments stored in the memory 1010.

The processor 1020 may receive, from a BS, CSI report configuration information including configuration information configuring the UE to report PQI about a PMI. The processor 1020 may receive a CSI-RS from the BS. The processor 1020 may control to transmit, to the BS, a CSI and the PQI about the PMI determined based on the CSI report configuration information and the CSI-RS.

The PQI about the PMI may include SGCS information or GCS about the PMI.

The CSI report configuration information may include a first field (reportQuantity) indicating a target to be measured for the UE to report as the CSI. The first field (reportQuantity) may include at least one of the PMI, the PQI about the PMI, CQI, a CRI, an LI, or an RI.

The CSI report configuration information may include a second field (reportFreqConfiguration) indicating a reporting configuration in a frequency domain. The second field (reportFreqConfiguration) may include a third field (PMI-FormatIndicator) indicating whether the UE is to report a wideband PMI or a subband PMI and a fourth field (pqi-FormatIndicator) indicating whether the UE is to report a wideband PQI or a subband PQI.

The CSI report configuration information may include a fifth field (nrofPQIs) indicating a number of PQIs reported in each rank (or RI) and a sixth field (layer2pqiMapping) mapping each layer to the PQI.

FIG. 11 illustrates a configuration of a BS according to an embodiment.

Referring to FIG. 11, a BS (or network) may include a processor 1120 controlling the overall operation of the BS (or network), a transceiver 1100 including a transmitter and a receiver, and memory 1110. Without limited thereto, the BS (or network) may include more or less components than those shown in FIG. 11.

The transceiver 1100 may transmit/receive signals to/from at least one UE. The signals transmitted/received with the at least one UE may include control information and data. The transceiver 1100 may also be referred to as a transmission/reception unit.

The processor 1120 may control the BS (or network) to perform any one of the above-described embodiments. The processor 1120, the memory 1110, and the transceiver 1100 are not necessarily implemented in separate modules but rather as a single component, e.g., a single chip. The processor 1120 and the transceiver 1100 may be electrically connected with each other. The processor 1120 may be at least one processor.

The memory 1110 may store a default program for operating the BS (or network), application programs, and data, such as configuration information. The memory 1110 provides the stored data according to a request of the processor 1120. The memory 1110 may include a storage medium, such as ROM, RAM, hard disk, CD-ROM, and DVD, or a combination of storage media. There may be provided a plurality of memories 1110. The processor 1120 may perform the above-described embodiments based on a program for performing the above-described embodiments stored in the memory 1110.

The BS in a wireless communication system comprises at least one transceiver; at least one processor communicatively coupled to the at least one transceiver; and at least one memory, communicatively coupled to the at least one processor, storing instructions executable by the at least one processor individually or in any combination to cause the base station to: transmit, to a user equipment (UE), channel state information (CSI) report configuration information including configuration information configuring the UE to report precoding matrix index (PMI) quality information (PQI); transmit a CSI-reference signal (CSI-RS) to the UE; and receive, from the UE, a CSI and the PQI determined based on the CSI report configuration information and the CSI-RS.

The processor 1120 may control to transmit, to a UE (UE), CSI report configuration information including configuration information configuring the UE to report PQI. The processor 1120 may control to transmit a CSI-RS to the UE. The processor 1120 may receive, from the UE, a CSI and the PQI determined based on the CSI report configuration information and the CSI-RS.

The methods according to the embodiments described in the disclosure may be implemented in hardware, software, or a combination of hardware and software. When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the disclosure.

The programs (software modules or software) may be stored in random access memories, non-volatile memories including flash memories, (ROMs, electrically erasable programmable read-only memories (EEPROMs), magnetic disc storage devices, compact-disc ROMs, DVDs, or other types of optical storage devices, or magnetic cassettes. The programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

The blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate indicates for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction indicates for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” indicates a software element or a hardware element such as a field-programmable gate array (FPGA) or an application specific integrated circuit (ASIC). A unit plays a certain role. However, a unit is not limited to software or hardware. A unit may be configured in a storage medium that may be addressed or may be configured to execute one or more processors. Accordingly, as an example, a unit includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the units may be combined into smaller numbers of components and units or further separated into additional components and units. The components and units may be implemented to execute one or more central processing units (CPUs) in a device or secure multimedia card.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a base station in a wireless communication system, the method comprising:
transmitting, to a user equipment (UE), channel state information (CSI) report configuration information including configuration information configuring the UE to report precoding matrix index (PMI) quality information (PQI);
transmitting a CSI-reference signal (CSI-RS) to the UE; and
receiving, from the UE, a CSI and the PQI determined based on the CSI report configuration information and the CSI-RS.

2. The method of claim 1,
wherein the PQI includes squared generalized cosine similarity information about a PMI or generalized cosine similarity about the PMI.

3. The method of claim 1,
wherein the CSI report configuration information includes a first field indicating a target to be measured for the UE to report as the CSI, and
wherein the first field includes at least one of a PMI, the PQI, channel quality information (CQI), a CSI-RS resource indicator (CRI), a layer indicator, or a rank indicator.

4. The method of claim 1,
wherein the CSI report configuration information includes a second field indicating a reporting configuration in a frequency domain, and
wherein the second field includes a third field indicating whether the UE is to report a wideband PMI or a subband PMI and a fourth field indicating whether the UE is to report a wideband PQI or a subband PQI.

5. The method of claim 1,
wherein the CSI report configuration information includes a fifth field indicating a number of PQIs reported in each rank and a sixth field mapping each layer to the PQI.

6. A method of a user equipment (UE) in a wireless communication system, the method comprising:
receiving, from a base station, channel state information (CSI) report configuration information including configuration information configuring the UE to report precoding matrix index (PMI) quality information (PQI);
receiving a CSI-reference signal (CSI-RS) from the base station; and
transmitting, to the base station, a CSI and the PQI determined based on the CSI report configuration information and the CSI-RS.

7. The method of claim 6,
wherein the PQI includes squared generalized cosine similarity information about a PMI or generalized cosine similarity about the PMI.

8. The method of claim 6,
wherein the CSI report configuration information includes a first field indicating a target to be measured for the UE to report as the CSI, and
wherein the first field includes at least one of the PMI, the PQI, channel quality information (CQI), a CSI-RS resource indicator (CRI), a layer indicator, or a rank indicator (RI).

9. The method of claim 6,
wherein the CSI report configuration information includes a second field indicating a reporting configuration in a frequency domain, and
wherein the second field includes a third field indicating whether the UE is to report a wideband PMI or a subband PMI and a fourth field indicating whether the UE is to report a wideband PQI or a subband PQI.

10. The method of claim 6,
wherein the CSI report configuration information includes a fifth field indicating a number of PQIs reported in each rank and a sixth field mapping each layer to the PQI.

11. A base station in a wireless communication system, comprising:
at least one transceiver;
at least one processor communicatively coupled to the at least one transceiver; and
at least one memory, communicatively coupled to the at least one processor, storing instructions executable by the at least one processor individually or in any combination to cause the base station to:
transmit, to a user equipment (UE), channel state information (CSI) report configuration information including configuration information configuring the UE to report precoding matrix index (PMI) quality information (PQI),
transmit a CSI-reference signal (CSI-RS) to the UE, and
receive, from the UE, a CSI and the PQI determined based on the CSI report configuration information and the CSI-RS.

12. The base station of claim 11,
wherein the PQI includes squared generalized cosine similarity information about a PMI or generalized cosine similarity about the PMI.

13. The base station of claim 11,
wherein the CSI report configuration information includes a first field indicating a target to be measured for the UE to report as the CSI, and
wherein the first field includes at least one of the PMI, the PQI, channel quality information (CQI), a CSI-RS resource indicator (CRI), a layer indicator, or a rank indicator.

14. The base station of claim 11,
wherein the CSI report configuration information includes a second field indicating a reporting configuration in a frequency domain, and
wherein the second field includes a third field indicating whether the UE is to report a wideband PMI or a subband PMI and a fourth field indicating whether the UE is to report a wideband PQI or a subband PQI.

15. The base station of claim 11,
wherein the CSI report configuration information includes a fifth field indicating a number of PQIs reported in each rank and a sixth field mapping each layer to the PQI.

16. A user equipment (UE) in a wireless communication system, comprising:
at least one transceiver;
at least one processor communicatively coupled to the at least one transceiver; and
at least one memory, communicatively coupled to the at least one processor, storing instructions executable by the at least one processor individually or in any combination to cause the UE to:
receive, from a base station, channel state information (CSI) report configuration information including configuration information configuring the UE to report precoding matrix index (PMI) quality information (PQI),
receive a CSI-reference signal (CSI-RS) from the base station, and
transmit, to the base station, a CSI and the PQI determined based on the CSI report configuration information and the CSI-RS.

17. The UE of claim 16,
wherein the PQI includes squared generalized cosine similarity information about a PMI or generalized cosine similarity about the PMI.

18. The UE of claim 16,
wherein the CSI report configuration information includes a first field indicating a target to be measured for the UE to report as the CSI, and
wherein the first field includes at least one of the PMI, the PQI, channel quality information (CQI), a CSI-RS resource indicator (CRI), a layer indicator, or a rank indicator.

19. The UE of claim 16,
wherein the CSI report configuration information includes a second field indicating a reporting configuration in a frequency domain, and
wherein the second field includes a third field indicating whether the UE is to report a wideband PMI or a subband PMI and a fourth field indicating whether the UE is to report a wideband PQI or a subband PQI.

20. The UE of claim 16,
wherein the CSI report configuration information includes a fifth field indicating a number of PQIs reported in each rank and a sixth field mapping each layer to the PQI.
